(19) United States
(12) Patent Application Publication
(10) Pub. No.: US 2024/0266870 A1
(43) Pub. Date: Aug. 8, 2024

(54) AD HOC BATTERY POWER GRID WITH INHERENT POWER SHARING

(71) Applicant: Smartville, Inc., Carlsbad, CA (US)

(72) Inventors: William von Novak, San Diego, CA (US); Megan Lloyd, San Diego, CA (US)

(21) Appl. No.: 18/431,581

(22) Filed: Feb. 2, 2024

Related U.S. Application Data
(60) Provisional application No. 63/483,102, filed on Feb. 3, 2023.

(51) Int. Cl. H02J 13/00

(52) U.S. Cl. CPC H02J 13/0004; H02J 13/00002

(57) ABSTRACT

A system, method and apparatus, and/or device is provided for an ad hoc grid network control. The system having a first node, the first node having a power source, one or more loads, a current sensor, a transmission line and a controller. The one or more loads in electronic communication with the power source. The first node current sensor configured to measure a first node current. The transmission line electrically connecting the first node to a second node, the transmission line having a circuit breaker and a second current sensor configured to measure a second node current, wherein the second node current is the current measurement of the transmission line between the first node and the second node. The controller configured to adjust the circuit breaker based on the first node current and the second node current.

### CROSS-REFERENCE TO RELATED APPLICATIONS

This application claims priority to and the benefit of, U.S. Provisional Patent Application No. 63/483,102, filed Feb. 3, 2023 and entitled “AD HOC BATTERY POWER GRID WITH INHERENT POWER SHARING,” which are hereby incorporated by reference herein.

### FIELD OF INVENTION

The present disclosure relates generally to power grids and, in particular, to power sharing by linking of ad hoc microgrids.

### BACKGROUND

Systems, methods, and devices that improve the ad hoc microgrid or power grids may be desirable. For example, it may be desirable to improve the connection between various ad hoc power grids to improve power efficiency and capacity. A microgrid is a partially or wholly isolated electrical grid which may comprise energy sources, energy storage devices, and control systems to provide energy or power to loads connected to the microgrid.

There is a need for power grids and microgrids used for a variety of purposes, including new residential or commercial communities and developments, remote civilizations, temporary developments such as job sites for manufacturing or mining, military bases, and the like. Microgrids have broad applications with the primary target of controlling power output to nodes connected to the microgrid.

Typically a centralized controller may be used to control the power supply, to provide proper output to loads. A centralized controller may comprise knowledge of transmission line capacities, breaker trip currents, available supply, estimated load and charge state of all batteries. A centralized controller may send instructions to batteries to either charge, discharge or idle. Generally, a central controller may have a complete understanding of the system topology and capability—and be configured to communicate directly with each element of the system.

This presents a problem when smaller power systems, rapidly deployed power systems, or systems with weak or nonexistent links to the grid (i.e. microgrids) are deployed. In some power grids, such as microgrids, the central controller may not be directly connected to all components or nodes, therefore the complete understanding and control is not available. A second problem occurs when small groups of people (indigenous tribes, small communities, religious groups and cooperative communities) want power, but do not want the ‘baggage’ grid-supplied power involves (e.g., urbanization, pavement, increased concentration of people, etc.).

Therefore, there is a need for control methods for microgrids that do not rely on top-down planning or on a centralized operations system, but rather a control method which may operate its own microgrid in a fashion that maximizes available power and minimizes downtime by sharing power with other nearby microgrids on an as-needed or as-available basis.

### SUMMARY

In general, one aspect of the subject matter described in this specification is an ad-hoc network system. The ad-hoc network system may include a first node. The first node may include a power source. The first node may further include one or more loads in electronic communication with the power source. The first node may further include a first node current sensor configured to measure a first node current. The first node may further include a transmission line electrically connecting the first node to a second node, the transmission line having a circuit breaker. The first node may further include a controller configured to adjust the circuit breaker based on the first node current.

In another aspect, the subject matter may be a grid network system. The grid network system may comprise a local node comprising a power source and a controller. The grid network system may further comprise a plurality of external nodes each electrically connected by a transmission line to the local node, each of the transmissions lines comprising a circuit breaker. The local node may be configured to send and receive power to each of the plurality of external nodes. The controller may be configured to disconnect one or more of the circuit breakers based on a voltage measurement of the local node.

In another aspect, a method for grid network control is provided. The method may include connecting a local node to an external node by a transmission line, the transmission line comprising a circuit breaker, the local node comprising a local controller. The method may further include receiving, by the local controller, a local node voltage and a local node current. The method may further include adjusting, by the local controller, the circuit breaker based on the local node voltage and the local node current.

### BRIEF DESCRIPTION OF THE DRAWING FIGURES

Additional aspects of the present disclosure will become evident upon reviewing the non-limiting embodiments described in the specification and the claims taken in conjunction with the accompanying figures, wherein like numerals designate like elements, and:

FIG. 1 illustrates an example grid network, including an exemplary node, in accordance with various embodiments.

FIGS. 2A-2B illustrate an example network of multiple nodes connected by circuit breakers, in accordance with various embodiments.

FIG. 3 illustrates a link between two nodes comprising converters, in accordance with various embodiments.

FIG. 4 illustrates a control system for controlling nodes and links, in accordance with various embodiments.

FIGS. 5A-5C illustrates various circuit breakers used on links between nodes, in accordance with various embodiments.

FIG. 6 illustrates a node control table, in accordance with various embodiments.

FIG. 7 illustrates a method for controlling a node, in accordance with various embodiments.

### DETAILED DESCRIPTION

Reference will now be made to the example embodiments illustrated in the drawings, and specific language will be used herein to describe the same. It will nevertheless be understood that no limitation of the scope of the disclosure is thereby intended. Alterations and further modifications of the inventive features illustrated herein, and additional applications of the principles of the disclosure as illustrated herein, which would occur to one skilled in the relevant art and having possession of this disclosure, are to be considered within the scope of the disclosure.

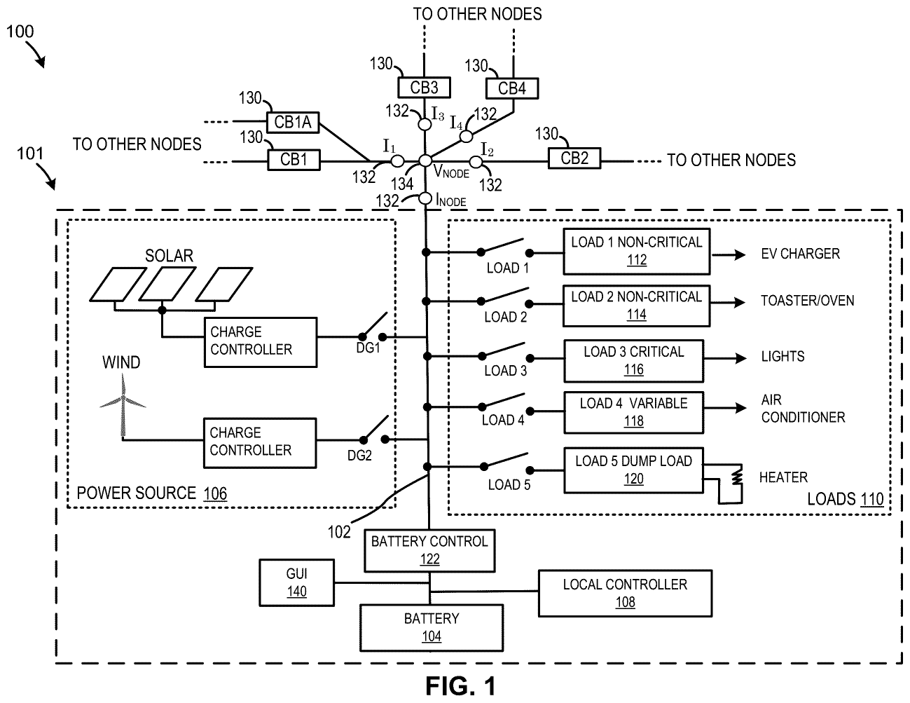

With reference to FIG. 1, an example grid network 100 is shown. In various embodiments, a grid network 100 may consist of a node 101 connected to various other nodes. In various examples, the node 101 may comprise of a network of various components. In various embodiments, the grid network 100 may be referred to as an ad hoc grid. In various embodiments, the grid network 100 may comprise one or more nodes 101, also referred to as network nodes, nodes, or just networks. In various embodiments, anode 101 may correspond to one location where power is needed—a home, a business, a government building, or a solar farm.

As shown in FIG. 1, the node 101 may comprise interconnect 102 with various components connected. In various embodiments, the components may be connected in series or parallel to each other in various configurations or topologies. In various embodiments, the interconnect 102 may consist of a central bus bar, such as a DC busbar. In various embodiments, the interconnect 102 may be a central connection point for loads 110 and power sources 106. In various embodiments, and as described in more detail herein, the node 101 may comprise a local controller 108 configured to control various components of the node 101, including the power source 106, battery 104 and/or the loads 110.

In an example embodiment, the node 101 may comprise a battery 104, a power source 106, a local controller 108 and/or a GUI 140. The node 101 may further comprise one or more loads 110. In various embodiments, each of the battery 104, power source 106, local controller 108, and one or more loads 110 may be connected to the interconnect 102.

In various embodiments, the battery 104 may be connected to the interconnect 102. The node 101 may further comprise a battery controller 122. The battery controller 122 may be used to control the power output from the battery 104, determine if the battery 104 is sufficiently charged and provide other controller functions to the battery 104.

In various embodiments, the power source 106 may include one or more power generation devices and power source controllers. For example, the power source 106 may include intermittent generation sources such as solar power or wind turbines. In various embodiments, although not shown, the power source 106 may comprise a dispatchable generator. Moreover, the power source 106 may comprise any suitable system for providing power to the node 101. In various embodiments, each of the power sources 106 may be electrically connected to the interconnect 102. The power sources 106 may each individually be connected to the interconnect 102 by a switch. For example, the solar panels may be connected the interconnect 102 by switch DG1. In various embodiments, the acronym DG may refer to distributed generation. For example, switch DG1 may refer to a switch in connection with first distributed generation source, such as solar. The one or more power sources 106 may further comprise a controller, such as a charge controller. In an example embodiment, the wind turbines may be connected, through a charge controller, to the interconnect 102 by switch DG2. The switches DG1 and DG2 may be controlled by a controller 108 to select power sources 106 to add to the node 101.

In various example embodiments, the one or more loads 110 may be connected to interconnect 102. In various embodiments, the loads 110 may include various loads, such as first non-critical load 112, second non-critical load 114, critical load 116, variable load 118, and/or dump load 120. The loads 110 may include one or more non-critical loads, such as the first non-critical load 112 and a second non-critical load 114, as shown in FIG. 1. In various embodiments, a non-critical load may be a load that is not critical to the user of the power grid, such an EV charger or toaster. The non-critical loads, such as first non-critical load 112 and second non-critical load 114, may be shed if necessary under certain circumstances. Thus, the first non-critical load 112 and second non-critical load 114 may be “sheddable” loads. There may be, in various example embodiments, any suitable number of sheddable loads.

In an example embodiment, the loads 110 may further comprise a critical load 116. In various example embodiments, a critical load 116 may be a load that is non-sheddable. In various examples, a critical load 116 may include components that are more critical to the user, such as emergency lights, blower fans for stairwells, elevator power supplies, and various safety functions.

In various example embodiments, the loads 110 may include a variable load 118. In accordance with various example embodiments, the variable load 118 may be a load that can be controlled or reduced. In other example embodiments, the variable load 118 may include components that require varying levels of power, such as air conditioning.

In various example embodiments, the loads 110 may further comprise a dump load 120. In various example embodiments, the dump load 120 may be used as a load that is available to receive energy to sink energy from the battery 104 if needed. For example, a dump load 120 may include a water heater. For example, the dump load 120 may be an opportunistic load that is not normally powered, but may dissipate excess energy into an auxiliary element such as water or store energy such as in pumped storage.

In various embodiments, each of the loads 110 may be connected to the interconnect 102 by a switch. The load switches many be controlled by a controller 108 to select where power is supplied.

In various embodiments, the node 101 may be connected to a plurality of other nodes. The node 101 may be connected to other nodes by circuit breakers 130, e.g. CB1, CB1A, CB2, CB3, CB4. In various embodiments, a current sensor 132 may be configured to measure the current through each of the one or more additional nodes, e.g. currents I1, I2, I3, and I4. In various embodiments, a current sensor 132 may be in communication with the controller 108. For example, the current sensor 132 may sense a current flow (e.g. one or more of currents I1, I2, I3, and I4) and transmit that current flow information to the controller 108.

In various embodiments, a node such as node 101 allows the construction and operation of much smaller battery-based networks that supply power to a community without a requirement for central planning and comprehensive knowledge of the system. For example, node 101 may be connected to additional same or substantially similar nodes to allow “ad-hoc” growth of a network, with additional generation, storage, loads and transmission added as needed in an organic fashion. For example, node 101 may also provide guidance on how to expand a network when it becomes overtaxed to help enable smaller communities to build and expand microgrids without the sort of central planning required for traditional grid systems.

In various embodiments, the node 101 may comprise local controller 108. Local controller 108 may monitor and control components of node 101 and additional components. For example, local controller 108 may be in communication with interconnect 102 and may monitor the voltage of interconnect 102.

In various embodiments, the node 101 may be connected to one or more transmission lines connecting the node 101 to other similar nodes. In various embodiments, each connection to other nodes may comprise a circuit breaker 130 (e.g. CB1, CB2, CB3, CB4). In various embodiments, as described herein, the connection to other nodes may contain a second circuit breaker (e.g. CB1A) in parallel with the first circuit breaker CB1. The node 101 may contain a current sensor 132. In various embodiments, the connection to other nodes may each contain a current sensor 132. The current sensor 132 may measure the current into or out of the respective transmission lines (e.g. I_{NODE}, I₁, I₂, I₃, I₄). In various embodiments, the current sensor 132 may measure the current I_{NODE} of node 101. In various embodiments, the node 101 may contain a voltage measurement device 134 to measure the voltage of the node called V_{NODE}.

In various embodiments, local controller 108 may monitor the voltage of V_{NODE} using the voltage measurement device 134. The local controller 108 may receive the current measurement of one or more of the transmission lines (e.g. I₁, I₂, I₃, I₄) from the current sensors 132. The local controller 108 may receive the current measurement of node 101, I_{NODE}, from the current sensors 132. The local controller 108 may determine based on the current measurement whether each transmission line is a source link, where a source link is a transmission line which is providing current to the node 101. The local controller 108 may determine, based on the current measurement, whether each transmission line is a sink link, wherein a sink link is a transmission line which is taking current from the node 101.

In various embodiments, the node 101 may contain a graphical user interface, GUI 140. The GUI 140 may comprise a screen or other display device. The GUI 140 may be in communication with a server (not shown). The GUI 140 may receive information from the node 101 and controller 108. The GUI 140 may be configured to display measurement data and statuses of loads 110, switches, circuit breakers 130, and/or power source 106. The GUI 140 may display the information received to a user.

In various embodiments, the controller 108 may comprise historical information. The controller 108 may store current and voltage measurements taken over a period of time. In various embodiments, the controller 108 may use historical information (such as historical current and voltage measurements) to control the components of the node 101 and/or the circuit breakers 130. The controller 108 may store the historical information in a database (not shown).

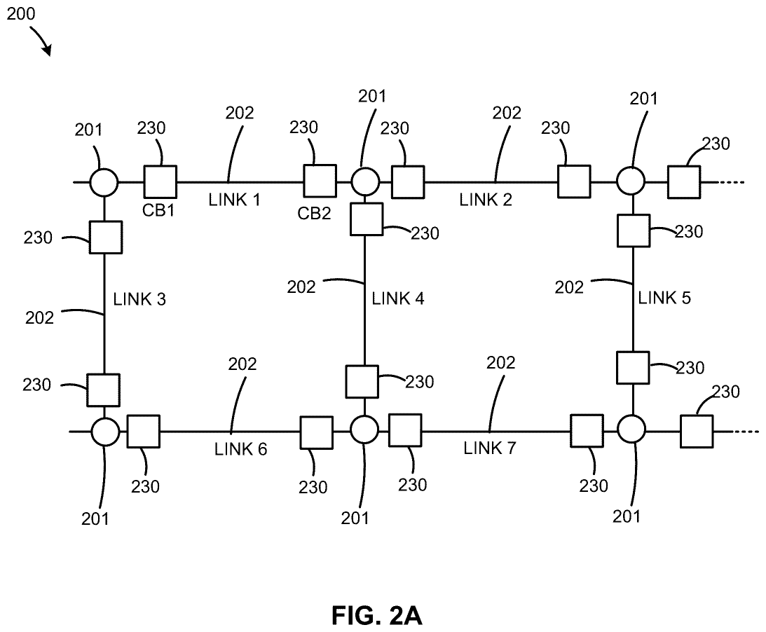

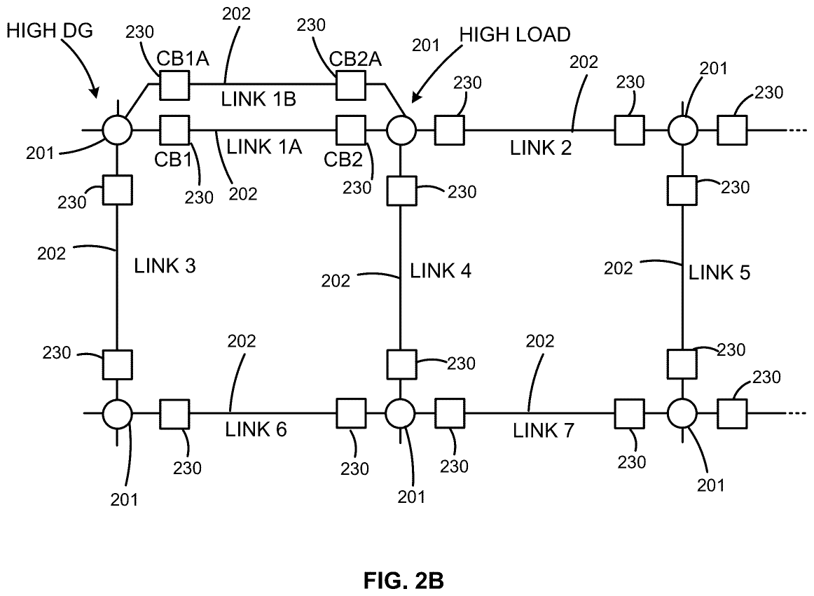

With reference now to FIGS. 2A and 2B, a grid network 200, in accordance with various embodiments is shown. The grid network 200 may include the features disclosed in reference to FIG. 1 and associated with grid network 100. In various embodiments, grid network 200 may comprise one or more nodes 201. The nodes 201 may include similar elements described in reference to FIG. 1 and associated with node 101.

In various embodiments, one or more of the nodes 201 may be connected to another node 201 by a link (e.g. LINK 1-7 as shown in FIGS. 2A and 2B). In various embodiments, one or more of the links may contain one or more circuit breakers 230. In an example embodiment, each node 201 may be connected to one or more other nodes 201 by a link comprising a first circuit breaker 230 and second circuit breaker 230. In various embodiments, a first circuit breaker 230 may be in proximity to a first node 201 and a second circuit breaker 230 may be in proximity to a second node 201. In various embodiments, the link between a first node 201 and a second node 201 may be substantially large. In various embodiments, the links may be current limited links between nodes 201 with each link protected by a circuit breaker 230 device on each side. In various embodiments, the link may comprise a transmission line 202. The transmission line 202 may connect the one or more circuit breakers 230. In various embodiments, the transmission line 202 may include a wiring gauge. For example, the transmission line 202 of LINK 1 may include a wiring gauge to achieve a given amount of voltage loss (for example, 3%) at maximum rated power.

With reference to FIG. 2B, in various embodiments, the grid network 200 may comprise multiple links between nodes 201. For example, in various embodiments, two nodes 201 may be connected by multiple links, as shown by LINK 1A and LINK 1B. In this embodiment, a first link LINK 1A and a second link LINK 1B may connect a first node 201 to a second node 201. In various embodiments, the two nodes 201 may be connected by a first transmission line 202 of LINK 1A and a second transmission line 202 of LINK 1 B. In various embodiments, LINK 1B may comprise one or more circuit breakers 130 (CB1A and CB1B), each connected to the transmission line 202. For example, LINK 1B may comprise a first circuit breaker 130 (CB1A), connected to a second circuit breaker 130 (CB2A), by the transmission line 202.

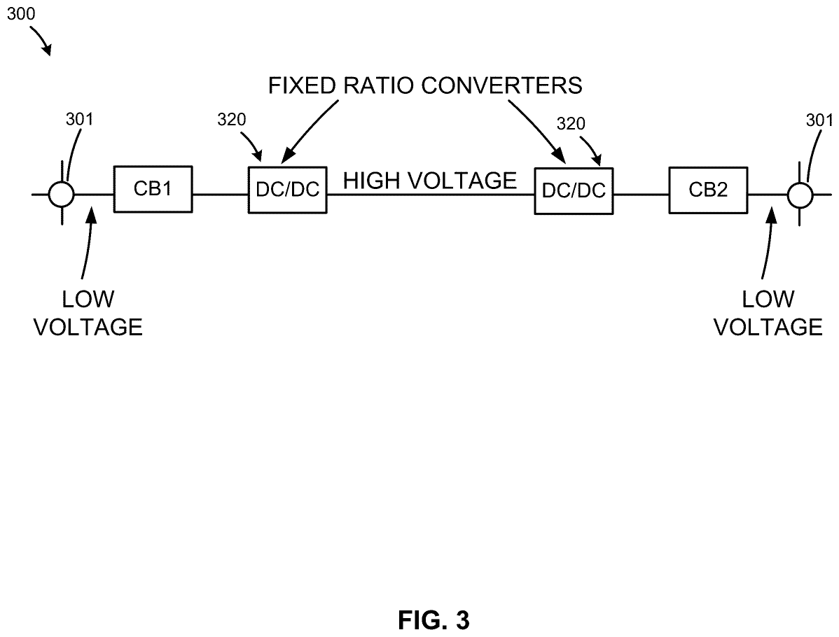

With reference to FIG. 3, a link 300 comprising a voltage boost is shown. The link 300 may comprise two nodes 301 (similar to nodes 101 of FIG. 1) connected by a link including converters 320. In various embodiments, where the distance between two nodes 301 is substantially long, converters 320 may be used to boost the voltage. For example, the link between two nodes 301 may include two converters 320, each in proximity to the respective nodes 301. In various embodiments, the converters 320 may be DC/DC converters. For example, the converters 320 may be used to increase and decrease the voltage to reduce losses as the current travels between the nodes 301. In various embodiments, the converters 320 may be bidirectional. The current, in various embodiments can be passed across the link and through the converters 320 in both directions. In various embodiments, the converters 320 may be bi-directional fixed ratio converters. For example, the voltage at a first node may be measured as a low voltage, be increased by a first converter 320, travel a substantial distance at a higher voltage, then decrease the voltage by a second converter 320, and travel to a second node 301 at a relatively low voltage measurement In accordance with this embodiment, the voltage at the first node 301 may be same or substantially similar to the voltage at the second node 301, to maintain a consistent voltage at the various nodes.

In various embodiments, with reference to FIG. 4 and FIGS. 1-3, a control system 400 for controlling voltage may be used. In various embodiments, a control system 400 may comprise controller 408 (similar to controller 108). In various embodiments, control system 400 may further comprise additional controllers 408 connected to additional nodes 401 and/or links 300. The control system 400 may monitor voltage signals and use voltage signals for control. In various embodiments, controller 408 may be in communication with a current sensor 132. The current sensor 132 may measure the current and communicate the measured current to the controller 408. In various embodiments, the control system 400 may monitor voltage to shed load and generation to and from various components. The control system 400 may monitor the voltage levels of the grid network 100, nodes 101, loads 110, links 300, converters 320, the current levels measured at I₁, I₂, I₃, I₄ and various other components described herein. For example, the control system 400 may measure the voltage of anode 101 and determine that a lower voltage indicates a node 401 (similar to node 101) that is lower in energy. In various embodiments, a battery based DC microgrid may be used, wherein voltage is a representation of energy state of the battery, and thus voltage provides information on this energy state. In various embodiments, where the control system 400 identifies a lower voltage, the control system 400 may shut down various loads 110. For example, the controller 408 may shutdown opportunistic loads such as non-critical loads including first non-critical load 112 and second non-critical load 114. The controller 408 may reduce power of variable loads 118 (air conditioning power, pump power, light intensity). In various embodiments, where the control system 400 identifies lower voltage, the controller 408 may shutdown critical loads 116 after shutting down non-critical loads 112, 114. The control system 400 may shutdown or reduce voltage to various loads 110 to reduce the load on the battery 104 of a node 401 and prevent voltage from becoming dangerously low.

In contrast, the control system 400 may determine a node 401 has a higher voltage measurement. When the control system 400 identifies a higher voltage, the controller 408 may shutdown or reduce power sources 106 and activate dump loads 120. When the control system 400 identifies a higher voltage, the control system 400 may control components to prevent voltage from rising to levels harmful to the battery 104. As shown in FIG. 1, components are controlled by the controller 108 by switches or other control devices. The controller 108 may activate a component by closing a switch or shutdown a component by opening the switch. Additionally, in various embodiments links 300 between nodes 301 may be controlled by the controller 108 or additional controllers of the control system 400 by circuit breakers 130.

Further, in various embodiments, controller 408 may be used to control links 300. For example, controller 408 may monitor and/or control circuit breakers 130. In various embodiments, controller 408 may be in effective communication with one or more other nodes 401. For example, controller 408 may receive currents and voltages of one or more nodes 401. For example, if the controller 408 identifies the local node 401 is experiencing a low voltage condition, indicating a low energy condition, the controller 408 may receive a current measurement of the current flowing out of the node 401 through a link 300, and the controller 408 may disconnect one or more of those links to prevent energy from dropping to a dangerously low level. In various embodiments, a controller 408 may determine that current is flowing into the node 401 through links 300, and the controller 408 may keep link 300 connected to attempt to ameliorate the low energy condition.

In various embodiments, the control system 400 may control links 300 between nodes 101. For example, the controller 408 or additional controller of the control system 400 may monitor currents of links 300 and/or nodes 301. The control system 400 may identify a high voltage condition, and the control system 400 may disconnect links 300 that are sourcing current into the node 401, accordingly the voltage will increase. In various embodiments, the control system 400 may also ensure that links 300 that are sending current out of the node 401 remain connected. In various embodiments, the control system 400 may identify a low voltage condition, and the control system 400 may disconnect links 300 that are sinking current out of the node 401 and hence reducing the voltage. The control system 400 may also ensure that links 300 that are sourcing current to the node 401 remain connected.

In various examples, links 300 between nodes 301 may be source links or sink links. For example, a source link may be a link 300 that is providing power to a node 301. A source link may be categorized by the control system 400 as a link 300 that is low, medium or high source link. For example, a link 300 that is categorized as a high source link provides more power to a node 301 than a medium or low source link, and a link 300 that is categorized as a low source link provides less power to a node 301 than a medium or high source link. In various embodiments a link 300 may be a sink link. For example, a sink link may be a link 300 to a node 301 that takes power from the node 301. A sink link may be categorized by the control system 400 as a link 300 that is low, medium or high sink link. For example, a link 300 that is categorized as a high sink link takes more power to a node 301 than a medium or low sink link, and a link 300 that is categorized as a low sink link takes less power from a node 301 than a medium or high sink link.

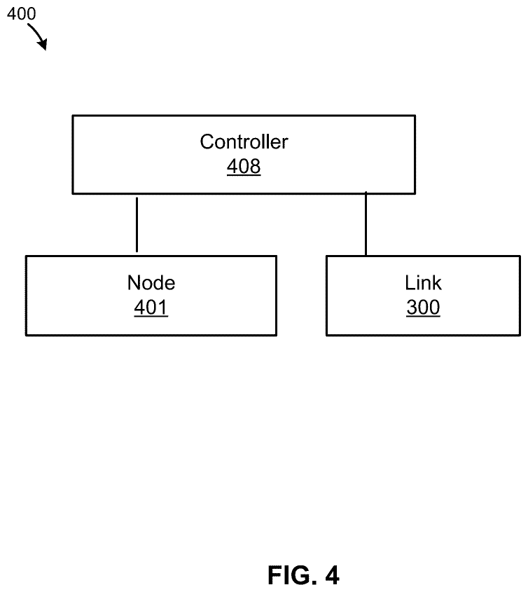

In various embodiments, control system 400 may identify a node 101 with a high level of power generation. For example, control system 400 may determine that there is a high level of power generation based on the amount of power generated by a power source 106 being greater than the power used by the loads 110. Further, in various embodiments, the control system 400 may identify a node 101 wherein the power used by the loads 110 is greater than the power generated by the power sources 106 of the node 101. In this example, the high power generation node 101 may provide power to the high power load node 101. In various embodiments, as shown in FIG. 2B, with continued reference to FIG. 4, a node 201 with high distributed power generation (HIGH DG as shown in FIG. 2B) may be connected to a node 201 with high power load (HIGH LOAD as shown in FIG. 2B). The control system 400 may measure a high current in LINK TA, where LINK TA connects a node 201 with high power generation to a node 201 with high power load. In this and various embodiments, a second link, LINK 1B, may be configured to connect node 201 with high power generation to node 201 with high power load. For example, when a second link is added between two nodes 201, the current across LINK 1A will reduce by approximately half. In various embodiments, the control system 400 may provide guidance to users who are able to add transmission lines (or improve existing transmission lines) to reduce currents high enough to overstress the existing transmission line. For example, the control system 400 may be configured such that controller 408 provides guidance via the GUI 140 to add or improve transmission lines based on historical usage.

In various embodiments, with reference to FIGS. 1 and 4, the control system 400 may control power source 106. For example, the controller 108 may monitor the voltage of interconnect 102. The controller 108 may close the switch to power source 106 to increase power supplied to node 101. In various embodiments, power sources 106 may be local power generation sources, such as wind turbines or photovoltaic solar systems. In various embodiments, power source 106 may comprise an emergency source, such as depletable fuels (i.e. a generator or fuel cell). In various embodiments, control system 400 may activate an emergency source where local power sources are insufficient. For example, controller 108 may activate an emergency power source to prevent loss of power where the voltage of the node 101 is at a low voltage level. In various embodiments, the control system 400 may provide power from a power source 106 from a second node 101. For example, under some conditions the control system 400 may allow power to be received by node 101 from a link 300 that is a source link. In various embodiments, the control system 400 may also allow the power from a power source 106 from node 101 to be sent to a second node 101.

In various embodiments, the control system 400 may control the dump load 120. A dump load 120 may be a load that is not normally needed, but available to sink energy if needed. The dump load 120 may be activated by the controller 108 to sink energy from the system. For example, the controller 108 may open the switch to the dump load 120 and the dump load 120 will not receive voltage from the node 101. In various embodiments, the control system 400 may identify a high voltage and close the switch to the dump load 120 to allow power to be provided to the dump load 120.

In various embodiments, the control system 400 may control the non-critical loads 112 and 114 to provide power when voltage levels are high or normal, but may open the switches to loads 112 and 114 when voltage is low to ensure energy does not fall to a dangerously low level.

In various embodiments, the control system 400 may control the critical load 116 and keep it connected under almost all conditions. The control system 400 may disconnect critical load 116 only when voltage falls to a critically low level that indicates the remaining energy is nearly zero. This maximizes availability of power for the critical load. In various embodiments, the critical load 116 may be a load that is more critical to a user such as lighting, safety, medical etc.

In various embodiments, the control system 400 may control the variable load 118 and allow it to operate normally under high voltage and normal voltage conditions. In various embodiments, a variable load 118 may be a load that varies in power, such as water pumps that can be throttled back where the voltage of the node 401 may be low. The control system 400 may reduce power to the load when the voltage falls to a low level, to reduce further drain on the energy source.

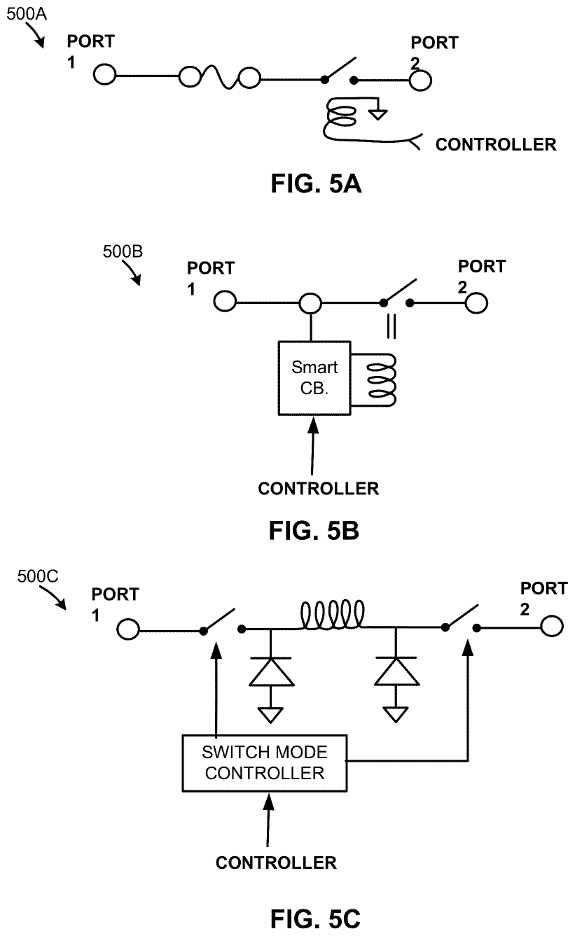

With reference to FIGS. 5A-5C, in various embodiments, nodes 101 are connected by links 300 comprising a circuit breaker 500A, 500B, 500C. For example, each link 300 comprises one or more circuit breakers 500A, 500B, 500C. The circuit breakers 500A, 500B, 500C may include the features of circuit breaker 130, as shown in FIGS. 1-3. In various embodiments, circuit breaker 500A, 500B, 500C, and 130 may be used to disconnect or reduce current. For example, circuit breaker 500A, 500B, 500C, and 130 may be used to disconnect or reduce current between two nodes 101 where there is overcurrent. Further, in various embodiments, circuit breaker 500A, 500B, 500C, and 130 may disconnect where the voltage of a node 101 is too high or too low. For example, control system 400 may disconnect the circuit breaker 500A, 500B, 500C, and 130 when the voltage of a node 101 is too high or too low, and the current flowing through the link is exacerbating that condition. In various embodiments, the circuit breaker 500A, 500B, 500C, and 130 may measure the current of the link 300 between two nodes 101. The circuit breaker 500A, 500B, 500C, and 130 may disconnect or reduce current of a link 300 where there is an identified fault. In various embodiments, the circuit breaker 500A, 500B, 500C, and 130 may protect the transmission line and/or operate as a switch.

With reference to FIG. 5A, in various embodiments, the circuit breaker 500A may comprise a fuse and a relay. For example, the fuse may provide overcurrent protection, and the relay can be opened to disconnect that transmission line if the controller finds it necessary.

With reference to FIG. 5B, in various embodiments, the circuit breaker 500B may comprise a controllable circuit breaker. The circuit breaker may open automatically if the current through the transmission line becomes too high, and may also be used to disconnect that transmission line if the controller finds it necessary.

With reference to FIG. 5C, in various embodiments, the circuit breaker 500C may comprise a switch mode converter. In this example, circuit breaker 500C may disconnect the link 300 or may limit current across the link 300 to a safe level for the transmission line. For example, the switch mode converter may have any suitable duty cycle for controlling the current over link 300. Moreover, any suitable circuit breaker may be used that may be controlled by the local controller 108.

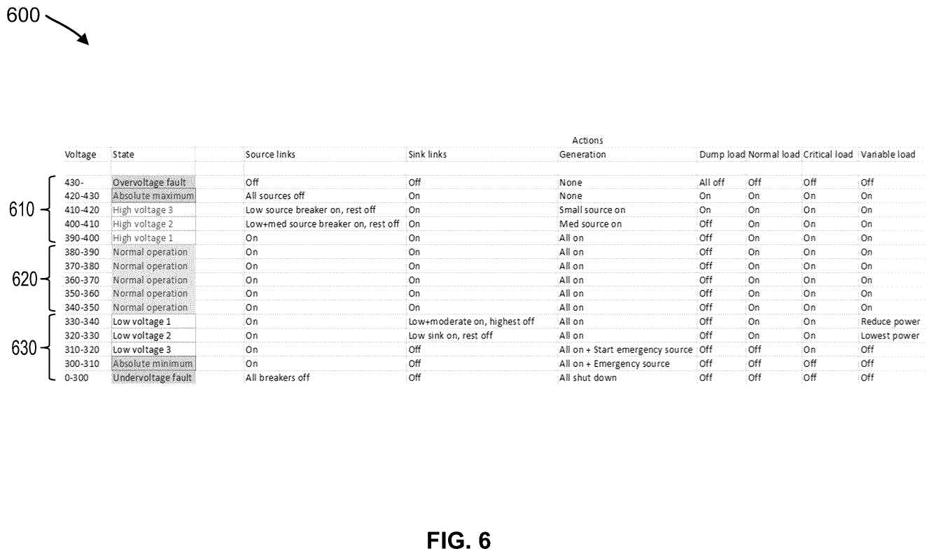

With reference to FIG. 6, a node control table 600 showing measurements and control is shown. The table 600 shows data received by controller 108 and the actions taken by controller 108. Stated another way, the controller 108 may be configured to look-up what actions it should take based on the voltage sensed by a voltage sensor at node 101. Although described herein in terms of a look up table, the controller can use any suitable method (function, relational database, etc.) to determine the control of the switches and circuit breakers based on the voltage sensed by the voltage sensor at node 101.

The table 600 may contain three categories of voltage measurements of the node, V_{NODE}. However, any suitable number of categories, and the range of the voltage subdivisions within those categories may be used. The high node voltage 610 is anode with a voltage above a high threshold node measurement. In table 600 the high threshold node measurement is 390 volts, however any suitable high threshold voltage may be used for the system. Therefore, in table 600, a high node voltage 610 is a node with a voltage equal to or greater than 390 Volts. The normal node voltage 620 is a node with a voltage below high threshold node measurement and above a low threshold node measurement. In table 600 the low threshold node measurement is 340 Volts, however any suitable low threshold voltage may be used for the system. Therefore, in table 600 a normal node voltage 620 is a node with a voltage measurement between 340 and 390 Volts. The low node voltage 630 is a node with a voltage below the low threshold node measurement.

As shown in table 600, the controller 108 may perform actions to connect, disconnect or adjust the current based on the voltage measurements of the node, V_{NODE}. In table 600, “Off” denotes that the component is disconnected. In various embodiments, a component may be disconnected by a switch, circuit breaker 130 or other electrical component capable of disconnecting current flow. In table 600, “On” denoted that the component is connected. In various embodiments, a component may be connected by closing a switch or circuit breaker 130 or other electrical component capable of starting current flow and stopping current flow. When the controller 108 identifies a high node voltage 610, the controller 108 may adjust a component to the “On” or “Off” position.

In various embodiments, when the node 101 is measured to have a high node voltage 610, the controller 108 may reduce or disconnect the current received by the source links. The controller 108 may reduce or disconnect the current received by the source links by controlling the circuit breaker 130. In various embodiments, if the node 101 is measured to have a high node voltage 610, the controller 108 may connect the dump load. For example, when there is a high node voltage 610, dump load 120 may be connect to sink current from node 101. In various embodiments, when the node 101 is measured to have a normal node voltage 620, the controller 108 may maintain the loads 110 are on with the exception of the dump load 120. In various embodiments, when the node 101 is measured to have a low node voltage 630, the controller 108 may reduce or disconnect the sink links by controlling circuit breaker 130. In various embodiments, when there is a low node voltage 630, the controller 108 may reduce or disconnect the variable load 118. In various embodiments, when there is a low node voltage 630, the controller 108 may disconnect one or more normal loads 112, 114. In various embodiments, when there is a low node voltage 630, the controller 108 may disconnect one or more of the critical loads 116. In various embodiments, when there is a low node voltage 630, the controller 108 may prioritize which loads 110 to disconnect first. For example, the controller 108 may disconnect or reduce power to the variable load 118, then the normal load 112, 114, then the critical load 116. Moreover, the controller 108 may disconnect all loads and links when there is an overvoltage fault or undervoltage fault.

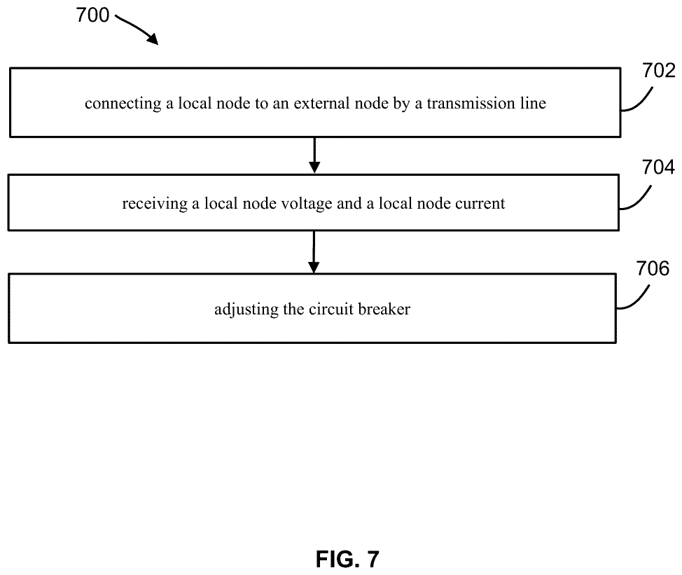

With reference to FIG. 7, a method 700 for grid network control is provided. In various embodiments, the method 700 may include connecting a local node to an external node by a transmission line (step 702). The transmission line may comprise a circuit breaker. The local node may comprise a local controller. The external node may be a node other than the node associated with the local controller. The method 700 may further include receiving, by the local controller, a local node voltage and a transmission line current (step 704). The local node voltage may be received from a local node voltage sensor, and the transmission line current may be received from a local node current sensor. The method 700 may further include adjusting, by the local controller, the circuit breaker based on the local node voltage and the transmission line current (step 706).

In various embodiments, the local node may comprise a power source, and one or more loads in electronic communication with the power source. In various embodiments, the method 700 may further include measuring by a current sensor the transmission line current. In various embodiments, the method 700 may further include determining, by the local controller, that the local node is a high node voltage based on the local node voltage, and the transmission line is a source link based on the transmission line current. In various embodiments, adjusting the circuit breaker, in method 700, may comprise reducing the current through the circuit breaker. In various embodiments, the method 700 may further include determining, by the local controller, that the local node is a sink node voltage based on the local node voltage, and that the transmission line is a source link based on the transmission line current. In various embodiments, the adjusting the circuit breaker of method 700 further comprises reducing the current through the circuit breaker.

### Examples of Ad-Hoc Network Guidance

Although ad-hoc network guidance is not limited to these examples, the examples below are illustrative of how the node controller can adapt or cause the network system to adapt to varying conditions. As described above, the node controller receives the voltage of the node's interconnect, the current in each transmission line going to/from the node, and the voltage in any transmission lines with an open circuit breaker. In an example embodiment, during normal operation of the node controller is configured to try to ensure that local loads are powered during normal conditions, and that during high or low voltage conditions (which equate to high or low battery charge conditions) the node controller may connect or disconnect transmission lines to attempt to maintain local energy storage levels.

In some cases, regular and repeated problems may be seen with the transmission lines. For example, if node 1 regularly has 100 amps of supply with no load, and node 2 regularly has 100 amps of load and no supply, and the two are connected directly, then the transmission line between them will try to transmit 100 amps. If the transmission line is only rated for 50 amps, the 50 amp circuit breaker will blow, and node 2 will lose power after it exhausts its local battery. The local controller may be configured to handle this situation in at least the following two ways.

In the first way, if the circuit breaker is configured as a switchmode protector, as shown in FIG. 5C. For example, the local controller may command the switchmode protectors to limit the current to the maximum safe rating for the transmission line. In this example, when the switchmode protector is utilized, then at least 50 amps will be transferred across the transmission line. This will allow for the transmission line to not cut off current and allow for critical loads powered.

In a second way, the local controller can provide guidance, e.g. through a graphical user interface, also referred to herein as a GUI, which may allow users to physically expand the capacity of the transmission line. In this example embodiment, because the node controller can see the currents in each transmission line, and can see when a breaker blows (by observing current going to zero and the voltage on both sides no longer being the same), or has to reduce the current using switch mode protectors, the controller can recommend fixes to the node operators. In this case, increasing the capacity of that transmission link to greater than 100 amps will fix the issue. That can be done by adding another 50 amp transmission line, or increasing the wire cross section (i.e. a higher rated transmission line) and upsizing the breaker to 100 amps. To do this the controller may be configured to estimate the new current requirement that the line will need. Doubling the transmission line capacity is a reasonable estimate in the absence of any other information, but often more information will be available.

In just one example embodiment, a battery at the node may be configured to generally either supply or accept all the current from the node (at least for a while), and in this example embodiment, a simple measurement of the battery current may provide the maximum current the link needs to carry. The transmission line will not have to carry more current than that, since while the link is connected, the battery will provide some of the current needed—so the transmission will always carry less than that peak.

As another example embodiment, if the source node is generating primarily via solar generation, then the 50 amp breaker will blow as soon as generation rises to 50 amps. Since the curve of solar generation during the day is fairly consistent across solar installations, the controller can extrapolate what the peak will be, and recommend that peak current as the new current requirement for the transmission line.

As yet another example, if the sink node is seeing primarily refrigeration or air conditioning loads, then the node controller can measure the local temperature and use that to extrapolate maximum current requirements based on known temperature extremes for the area. (Either via commonly available data or recording of local temperature data.)

In the present disclosure, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide. Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in the numerical range are individual values such as 2, 3 and 4 and sub-ranges such as 1-3, 2-4 and 3-5, etc. The same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a defacto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

It should be appreciated that the particular implementations shown and described herein are illustrative of the example embodiments and their best mode and are not intended to otherwise limit the scope of the present disclosure in any way. Furthermore, the connecting lines shown in the various figures contained herein are intended to represent example functional relationships and/or physical couplings between the various elements. It should be noted that many alternative or additional functional relationships or physical connections may be present in a practical device.

As one skilled in the art will appreciate, the mechanism of the present disclosure may be suitably configured in any of several ways. It should be understood that the mechanism described herein with reference to the figures is but one example embodiment of the disclosure and is not intended to limit the scope of the disclosure as described above.

It should be understood, however, that the detailed description and specific examples, while indicating example embodiments of the present disclosure, are given for purposes of illustration only and not of limitation. Many changes and modifications within the scope of the instant disclosure may be made without departing from the spirit thereof, and the disclosure includes all such modifications. The corresponding structures, materials, acts, and equivalents of all elements in the claims below are intended to include any structure, material, or acts for performing the functions in combination with other claimed elements as specifically claimed. The scope of the disclosure should be determined by the appended claims and their legal equivalents, rather than by the examples given above. For example, the operations recited in any method claims may be executed in any order and are not limited to the order presented in the claims. Moreover, no element is essential to the practice of the disclosure unless specifically described herein as “critical” or “essential.”

What is claimed:

1. An ad-hoc network system comprising:
a first node comprising:
a power source;
one or more loads in electronic communication with the power source;
a first node current sensor configured to measure a first node current; and
a transmission line electrically connecting the first node to a second node, the transmission line having a circuit breaker; and
a controller configured to adjust the circuit breaker based on the first node current.

2. The system of claim 1, further comprising a voltage sensor configured to measure a first node voltage, wherein the controller is configured to adjust the circuit breaker based on the first node voltage.

3. The system of claim 1, further comprising a battery, wherein the battery is configured to receive power from the power source.

4. The system of claim 3, wherein the battery is configured to provide power to the one or more loads.

5. The system of claim 2, wherein the controller is configured to disconnect the one or more loads based on the first node voltage, the first node current and a second node current.

6. The system of claim 2, further comprising a second transmission line electrically connecting the first node to the second node, the transmission line having a second circuit breaker, the controller configured to adjust the second circuit breaker based on the first node voltage.

7. The system of claim 1, wherein the transmission line further comprises a second current sensor configured to measure a second node current, wherein the second node current is a current measurement of the transmission line between the first node and the second node.

8. The system of claim 2, wherein the controller is configured to selectively connect and disconnect each of the one or more loads based on the first node voltage.

9. A grid network system comprising:
a local node comprising a power source and a controller;
a plurality of external nodes each electrically connected by a transmission line to the local node, each of the transmission lines comprising a circuit breaker;
wherein the local node is configured to send and receive power to each of the plurality of external nodes; and
wherein the controller is configured to disconnect one or more of the circuit breakers based on a voltage measurement of the local node.

10. The system of claim 9, further comprising a current sensor configured to measure a local node current and to measure a transmission line current for each of the transmission lines, wherein the controller is configured to disconnect one or more of the circuit breakers based on the voltage measurement of the local node.

11. The system of claim 9, wherein the local node further comprises a battery, wherein the battery is configured to receive power from the power source.

12. The system of claim 11, wherein the local node further comprises one or more loads.

13. The system of claim 12, wherein the battery is configured to provide power to the one or more loads.

14. The system of claim 13, wherein the controller is configured to disconnect the one or more loads based on the voltage measurement of the local node.

15. The system of claim 10, wherein the controller is configured to disconnect the one or more of the circuit breakers based on the transmission line current.

16. The system of claim 12, wherein the controller is configured to selectively connect and disconnect each of the one or more loads based on the voltage measurement of the local node.

17. A method for grid network control comprising:
connecting a local node to an external node by a transmission line, the transmission line comprising a circuit breaker, the local node comprising a local controller;
receiving, by the local controller, a local node voltage and a local node current; and
adjusting, by the local controller, the circuit breaker based on the local node voltage and the local node current.

18. The method of claim 17, wherein the local node comprises a power source, and one or more loads in electronic communication with the power source.

19. The method of claim 17, further comprising:
measuring, by a current sensor, a transmission line current.

20. The method of claim 19, further comprising;
determining, by the local controller, the local node is a high node voltage based on the local node voltage, and the transmission line is a source link based on the transmission line current.

21. The method of claim 20, wherein the adjusting the circuit breaker comprises reducing a current of the circuit breaker.

22. The method of claim 19, further comprising;
determining, by the local controller, the local node is a low node voltage based on the local node voltage, and the transmission line is a source link based on the transmission line current.

23. The method of claim 22, wherein the adjusting the circuit breaker comprises reducing a current of the circuit breaker.
